(19) United States
(12) Patent Application Publication
(10) Pub. No.: US 2012/0166276 A1
(43) Pub. Date: Jun. 28, 2012

(54) FRAMEWORK THAT FACILITATES THIRD PARTY INTEGRATION OF APPLICATIONS INTO A SEARCH ENGINE

(75) Inventors: Pushkar Vijay Chitnis, Bangalore (IN); David Kojo Hutchful, Bangalore (IN); Chinmay Eishan Kulkarni, Stanford, CA (US)

(73) Assignee: Microsoft Corporation, Redmond, WA (US)

(21) Appl. No.: 12/979,357

(22) Filed: Dec. 28, 2010

(51) Int. Cl. G06F 17/30; G06Q 30/00

(52) U.S. Cl. 705/14.49; 707/706; 707/E17.014

(57) ABSTRACT

Described herein are technologies pertaining to executing a third-party application under the umbrella of a general purpose search engine. A software development kit is provided to a developer, and the developer uses the software development kit to develop an application that executes in a browser in a graphical user interface corresponding to a search engine. An end user provides a query to the search engine, and based at least in part upon the query the application generated by the third party developer is presented to the user. The application presented to the user potentially assists the user in search visualization and task completion.

### BACKGROUND

Computer implemented search engines are configured to search for information that is available by way of the World Wide Web. Conventionally, search engines are configured to receive a query and then execute a search over an index of web pages that is maintained/updated by the search engine. Based upon such search, the search engine can return a list of search results to the issuer of the query. These search results can include links to web pages, images and/or other types of files. Sophistication of algorithms utilized in search engines to locate search results has increased greatly over the last several years. Thus, even as more and more documents become available by way of the World Wide Web, conventional search engines are continuing to provide increasingly relevant results to issuers of queries.

One mechanism utilized by search engines to improve the relevance of search results with respect to informational interest of the user is the integration of one or more vertical domains into the search engine. Exemplary vertical domains include images, videos, shopping, news, maps, travel, etc. Thus, for example, if an issuer of a query wished to search for particular news items, the issuer of the query may first indicate that they are interested in searching the vertical (domain) “news item” by selecting a selectable link corresponding to news items on a home page of the search engine. This can limit the search to documents in the vertical selected by the user (news items). Additionally or alternatively, different algorithms can be employed depending on which vertical is selected by the user.

Currently, search engines dedicate their time and resources to target popular information domains (verticals) such as the aforementioned verticals listed above. These verticals tend to be relevant to used by a relatively large number of people. For example, many people choose to shop for particular products by searching for products using a “shopping” vertical. These popular verticals provided by search engines attract high search volumes and/or relatively long search sessions, which can be conducive to revenue generation for the search engine. It can be ascertained, however, that verticals that may be of interest to a relatively small portion of the population are ignored. This is because search engine companies typically do not have the time or resources to cater to everyone's informational needs with respect to certain verticals.

Accordingly, oftentimes people or groups that are experts in a particular domain/vertical generate custom application/search portals that allow users thereof to locate particular documents or be provided with a certain visualization pertaining to that vertical. This requires, however, not only that the individuals be experts in this domain but that they also have some experience programming search-related applications and/or visualizations. Furthermore, locating these customized portals can be difficult for users. That is, their discoverability is relatively low.

### SUMMARY

The following is a brief summary of subject matter that is described in greater detail herein. This summary is not intended to be limiting as to the scope of the claims.

Described herein are various technologies pertaining to causing a search engine to support integration of third party customized applications that appear under the umbrella of the search engine. To facilitate creation of such third party applications, the search engine can make a software development kit available to developers that wish to create customized applications/visualizations that will be shown under the umbrella of the search engine. For instance, the software development kit can support multiple different programming languages, including but not limited to C# and JavaScript. Using this development kit, developers can create search applications and visualizations that are supported by the general purpose search engine. In a particular example, the software development kit can provide a set of interfaces that allows applications developed through such software development kit to leverage application programming interfaces of the search engine and user query information to provide a customized search experience (for a vertical desired by the third party developer). The software development kit can include appropriate binaries and a publisher such that the customized application can be published to a deployment service.

Once such application has been developed by the third party, it can be provided to the search engine by way of a deployment service. After the application has been provided to the search engine, basic validation can be undertaken that allows the developer of the application to test such application prior to deployment of the application to the general public.

Subsequent to the application being validated and published, the customized application developed by the third party can be made available by way of a graphical user interface corresponding to the search engine. For example, a user can access the general purpose search engine by directing an Internet browser to a URL of such search engine. At this point in time, a home page of the search engine can be presented to the user, wherein such home page includes a text entry field that facilitates receipt of a user query. Once the user issues the query to the search engine, the search engine can perform a conventional web search and can thus locate search results that are relevant to the query. These search results can include images, web pages, word processing documents, etc. Additionally, the search engine can perform a search for customized third party applications that have been submitted to the search engine based at least in part upon the query and/or the search results located by way of the query. For instance, a keyword can be assigned to a particular application, and if a user issues a query that includes that keyword, the application can be presented to the user together with the conventional web search results. In another example, if a threshold percentage of a top N search results includes the keyword, then the application that has been assigned such keyword can be presented to the user together with the search result.

Thereafter, the user may select the application in the graphical user interface of the search engine. Consequently, the application and visualizations corresponding thereto can be presented to the user in another graphical user interface of the search engine. For instance, the application can be a search-related application customized by a third party that is configured to perform a search over a certain domain. In an example, a user may wish to search from amongst computer science related research documents. The user can issue a query (computer science papers) to a search engine, and the search engine can return conventional search results together with a link to a customized search application that is configured to only search over computer science documents. The user can select such selectable link and be provided with the customized search functionality which remains under the umbrella of the general purpose search engine. This arrangement is mutually beneficial, as the third party application will receive a higher amount of traffic due to increased discoverability while the search engine will receive a higher amount of traffic from users that wish to perform searches over specialized domains.

Other aspects will be appreciated upon reading and understanding the attached figures and description.

### BRIEF DESCRIPTION OF THE DRAWINGS

FIG. 1 is a functional block diagram of an exemplary system that facilitates displaying a third party search related application to a user of a search engine.

FIG. 2 is a functional block diagram of an exemplary system that facilitates automatically providing a browser executing on a client computing device with framework/application data that supports execution of a third party application in a search engine.

FIG. 3 is an exemplary graphical user interface.

FIG. 4 is an exemplary graphical user interface.

FIG. 5 is a flow diagram that illustrates an exemplary methodology for causing a third party application to be displayed in a graphical user interface corresponding to a search engine.

FIG. 6 is a sequence diagram illustrating communications between the World Wide Web, a search engine, a client computing device, and a user.

FIG. 7 is an exemplary sequence diagram that illustrates communications between the World Wide Web, the search engine, a client computing device, and a user.

FIG. 8 is a sequence diagram that illustrates exemplary communications between the World Wide Web, third party data providers and components of a browser.

FIG. 9 is an exemplary computing system.

### DETAILED DESCRIPTION

Various technologies pertaining to integrating third party applications into a search engine will now be described with reference to the drawings, where like reference numerals represent like elements throughout. In addition, several functional block diagrams of exemplary systems are illustrated and described herein for purposes of explanation; however, it is to be understood that functionality that is described as being carried out by certain system components may be performed by multiple components. Similarly, for instance, a component may be configured to perform functionality that is described as being carried out by multiple components. Additionally, as used herein, the term “exemplary” is intended to mean serving as an illustration or example of something, and is not intended to indicate a preference.

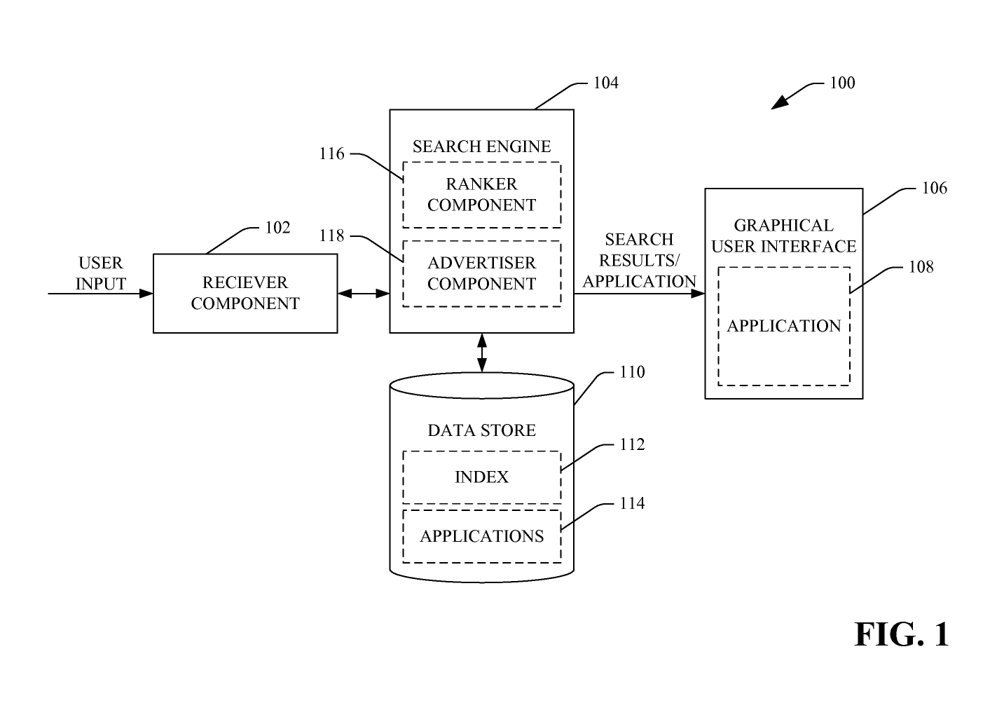

With reference to FIG. 1, an exemplary system 100 that facilitates providing a user with a visualization/third party application in a graphical user interface corresponding to a search engine is illustrated. The system 100 comprises a receiver component 102 that receives input from a user. The user input may be, for instance, a query or a selection of a selectable link on a web page. Additionally, the user input may refer to the directing of a browser to a particular URL, spoken commands of a user, etc.

A search engine 104 is in communication with the receiver component 102 and can present a graphical user interface 106 to the user based at least in part upon the user input. The graphical user interface 106 can correspond to the search engine such that one viewing the graphical user interface 106 can understand that they are still under the umbrella of the search engine. Responsive to the user input, the search engine 104 can present a third party application 108 in the graphical user interface 106, wherein the third party application 108 is associated with a particular domain (also referred to as a vertical). Thus, the user, through use of the search engine 104, can have access to a customized third party application/visualization pertaining to a vertical that is of interest to the user. The system 100 further comprises a data store 110 that is accessible to the search engine 104, wherein the data store 110 can comprise an index of web pages made available by way of the World Wide Web as well as applications that have been generated by entities other than the search engine 104 (third party applications).

Pursuant to an example, the user input received by the receiver component 102 can be a query. The search engine 104 can receive the query and can perform a search over web pages in the index 112 based at least in part upon the received query. The search engine 104 may locate documents in the index 112 based at least in part upon the query, wherein such documents can be considered search results that are to be provided to the issuer of the query. The search engine 104 can additionally search over the customized third party applications 114 based at least in part upon the query issued by the user and/or the search results located by the search engine 104. Additionally or alternatively, the search engine 104 can search over the customized third party applications 114 based at least in part upon previous queries issued by the same user or search results previously provided to the user and/or selected by the user.

In an example, each of the applications 114 may have a signature corresponding thereto, and the application 108 presented on the graphical user interface 106 by the search engine 104 can be provided to the issuer of the query based at least in part upon the signature corresponding to the application 108. A signature can be selected or assigned in a variety of manners. For instance, the signature can be or include features that are based upon a particular keyword, wherein if a user issues a query that includes such keyword (or the features that are based upon the keyword), then the application 108 will be returned to the user by the search engine 104. In another example, the signature may have features based upon a keyword assigned thereto, and the signature may further require that a certain percentage of the top N search results provided to the user include such keyword in the title of the web pages. In still yet another example, the signature assigned to the application 108 may be a particular web page, wherein the particular web page must be included within a top M search results by search engine 104 to provide the application 108 to the user in the graphical user interface 106. Accordingly, the search engine 104 can include a ranker component 116 that can receive the query and/or search results returned responsive to receipt of the query as well as contextual data pertaining to the user (and possibly) other information and can analyze signatures of the application 114 to rank such applications. For instance, the ranker component 116 can assign scores to applications in the applications 114 of the data store 110 and can return an application with the highest score to the user. In another example, the search engine 104 can return all applications that have scores above a certain threshold to the user.

In another example, the signature can include a third-party service (provided by the third-party application developer) which, when provided with an input query, can return a preliminary rank score within a certain response time. The preliminary rank can be processed by the ranker component 116 based at least in part upon at least one of user preference data, click through rates, user rankings, etc. to generate a final rank for an application. If the third-party rank service fails to return data pertaining to the application in a specified response time, the corresponding application is not displayed with other search results. Other embodiments for presenting the application 108 to the user are contemplated and intended to fall under the scope of the hereto appended claims.

Pursuant to a particular example, the search engine 104 can provide a selectable link to the application 108 in a graphical user interface together with conventional search results. Thereafter, the user can access the application by selecting the selectable link shown in the graphical user interface. Selection of the selectable link by the user can initialize the application in the browser of the user, wherein such application remains shown in a graphical user interface corresponding to the search engine 104.

In some embodiments, user-consent can be leveraged for applications where explicit user-consent is desired for reasons including but not limited to reasons pertaining to business issues, legal issues, etc. In such a case, the user can explicitly agree to allow these applications to be utilized and shown as search results. In another example, user-feedback in terms of ranking is leveraged to compute the rank of an application for a particular user. A vote up would bias the application such that it ranks higher for the particular user. A vote down would blacklist the application for the user and it will not be provided to the user as part of the search results.

The search engine 104 can additionally include an advertiser component 118 that selectively presents advertisements to the user when the application 108 is executing in the browser of the user. Pursuant to an example, the advertiser component 118 can cause revenue to be shared between the application 108 and the search engine 104 when advertisements are presented to the search engine 104. The advertiser component 118 can select advertisements to present to the user based at least in part upon an initial query received by the search engine 104, based upon one or more keywords in the signature corresponding to the application 108 shown in the graphical user interface 106, subsequent queries or input to the application 108 by the user, etc.

Furthermore, the user can access the graphical user interface 106 without providing a query to the search engine 104. For instance, a URL corresponding to the application 108 in the graphical user interface 106 can be directly entered into a browser of the user. Again, this URL may correspond to a same domain as a search engine 104. Furthermore, the user input may be selection of a link on another web page that directs the user to the graphical user interface 106 that includes the application 108. Other mechanisms for being provided the application 108 and the graphical user interface 106 are contemplated and are intended to fall under the scope of the hereto appended claims.

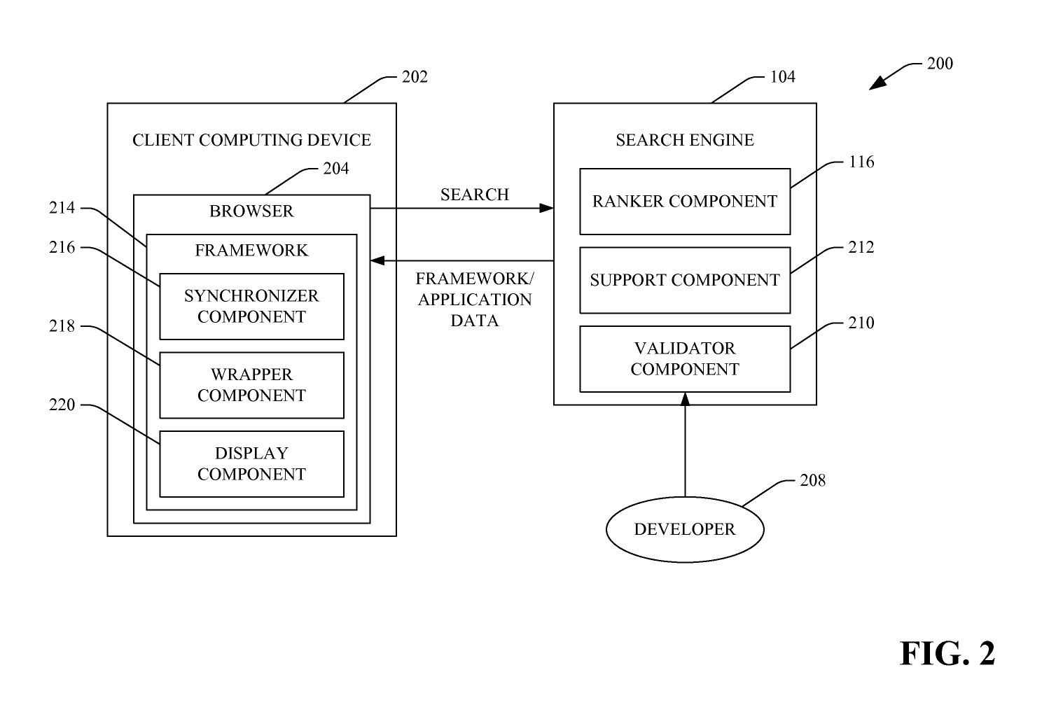

With reference now to FIG. 2, a functional block diagram of an exemplary system 200 that facilitates configuring a browser executing on a client computing devices to display and execute third party applications therein is illustrated. The system 200 comprises a client computing device 202, which may be any suitable client computing device such as a personal computer, a laptop computer, a tablet computer, a mobile telephone, a multimedia player, a gaming console, etc. The computing device 202 can have an Internet browser 204 executing thereon, wherein a user can direct the Internet Browser to a URL corresponding to a general purpose search engine.

The system 200 further comprises the search engine 104 that is configured to receive queries submitted by a user by way of the browser 204. For example, the user can direct the browser 204 to a URL corresponding to the search engine 104 and can issue a query to the search engine 104 by way of a text entry field displayed on the browser 204. It is to be understood, however, that other input mechanisms can be utilized to receive a query from a user, such as a microphone, a camera coupled with gesture recognition technology, etc. The search engine 104 may be executing in a server or a cluster of servers housed in a data center. Pursuant to an example, a developer 208 can submit a customized search application/visualization to the search engine 104. For instance, the search engine 104 may make available a software development kit, wherein the software development kit may be made available for multiple programming languages (e.g., C#, JavaScript, etc.). The software development kit can enable the developer 208 to generate or design search related applications and visualizations (controls utilized in connection with developing visualizations will be described in greater detail below). The software development kit made available to the developer 208 can provide a basic set of interfaces that allow applications/visualizations generated by developers to leverage application programming interfaces of the search engine 104. Additionally, the software development kit can provide mechanisms for accessing query configuration information to provide customized search experiences to an end user. Tools that can be included in the software development kit can comprise binaries and a publishing mechanism that allows the developer 208 to publish the application to the search engine 104.

The search engine 104 can further comprise or be associated with a validator component 210 that can facilitate submission of applications by the developer 208 to the search engine 104. The validator component 210 can receive an application developed by the developer 208 and can perform basic validation on such application. The validator component 210 can also facilitate allowance of a developer 208 to test an application prior to such application being deployed to the general public by way of the search engine 104.

As indicated above, the user of the client computing device 202 can submit a query to the search engine 104 by way of the browser 204. The search engine 104 can comprise the ranker component 116 that can rank applications submitted by third party developers based at least in part upon, for instance, user context, contents of the query, contents of the search results retrieved by the search engine 104, or other suitable mechanisms for ranking applications.

The search engine 104 comprises a support component 212 that can support execution of the application in the browser 204 on the client computing device 202. For instance, the framework 214 can be coded using javascript and included in a javascript file that is referenced by a search engine web page. When a new update is needed, the javascript file on the server-side is updated. In this example, cache policies of the browser 204 can provision caching of framework javascript to avoid fetching the framework javascript for each query. Other mechanisms for developing and pushing the framework 214 to the browser 204 are also contemplated. For example, if the user is initially accessing a third party application supported by the search engine 104 (accessing a third party application for the first time), then the support component 212 can transmit a framework 214 to the client computing device, such that the framework 214 can become, for instance, a plug-in for the browser 204. This framework 214 can include controls (controls made available to the developer 208 when developing the application by way of the software development kit) and configurations of such controls as defined by the developer 208.

For example, a control can be an event producing control or an event consuming control, and the configuration can define which events are to be produced by which controls and which events are to be consumed by which controls, thus defining functionality/visualizations of the application in the browser 204 on the client computing device 202. Again, for instance, upon the user initially selecting an application to execute on the browser 204 of the client computing device 202, the user can consent to receiving the framework as well as updates to such framework when additional or alternative applications are selected by the user. If the user has previously consented to receiving data that supports execution of third party applications by way of a search engine 104, then upon the user proffering the query to the search engine 104, the support component 212 can automatically transmit controls/configurations pertaining to applications that may be relevant to the query or desired by the user to the browser 204. Thus, the user need not consent to each configuration pertaining to different applications supported by the search engine 104. In some embodiments, such as when the framework 214 is implemented utilizing javascript, the user need not explicitly consent to receiving the framework 214.

The framework 214 executing on the browser 204 facilitates receipt of controls/configuration that update the framework 214. For instance, the framework 214 can comprise a synchronizer component 216 that facilitates synchronization of client side third party plug-ins (controls configured by the developer 208). For example, the framework 214 can consider a third party application as a number of inter-related controls made available to the developer 208 by the software development kit. Each plug-in/control can specify a kind of data consumed by the control, a kind of data produced by the control, events that can be fired by the control when data consumed by such control alters, event hooks that are called by the control when the data produced by the control alters, amongst other interactions defined by the developer 208. Furthermore, a control can specify different display functionality that the control provides and at what time such control should be loaded, such that a particular visualization is presented to the end user. When the support component 212 of the search engine 104 transmits controls and configurations to the client computing device 202, the synchronizer component 216 can register such controls. Registration can transfer appropriate metadata to the framework 214, and the synchronizer component 216 can then synchronize data between the controls. The metadata includes the kind of data consumed by the controls, the kind of data produced by the controls, the events described above, and display parameters corresponding to the controls.

Additionally, it is to be understood that the controls mentioned above can be created by third-party application developers. The software development kit provided to the developers can comprise common controls for such developers to employ when developing applications, but the developers can generate additional, more customized controls if desired. The predefined controls in the software development kit can be provided to the end-user (e.g., to the browser 204) along with the framework 214 or within the third-party application when selected by the end user. Customized controls generated by the third-party developer can be provided within the third-party application when selected by the end user.

It is to be understood that controls passed to the framework 214 by the support component 212 are not search applications themselves, but are subcomponents which make up a particular application. For instance, these controls can be self-contained units of functionality and thus can be reused across several different third party application. The exemplary controls can include calendar views for temporal data, slide show controls for display of images, amongst others.

Controls can fire custom events that are customized by the developer 208, and the synchronizer component 216 can pass custom events to other controls that have registered to listen to such event. An exemplary event can be a change of a currently selected data in a calendar, which may cause other controls to refresh a view corresponding thereto.

In a particular embodiment, the metadata describing interaction of the controls can be packaged in an XML manifest file for a particular application. Such manifest file can reduce a number of files that must be downloaded to the browser 204. Further, manifest files for all applications shown to a user on a search page can be placed into a single file.

It is to be understood that the framework 214 can be development technology agnostic, which allows the developer 208 to create controls in various languages such as JavaScript, Flash or the like. In addition to synchronization between JavaScript controls, which can occur through direct function calls in JavaScript, the framework 214 can support synchronization among the aforementioned programming technologies. This can be achieved by creating libraries in a particular technology that act as a bridge to the framework 214. Such libraries can be considered as thin wrappers that perform tasks such as translating function calls and native code to JavaScript, marshalling data formats, and converting JavaScript function calls into native events.

The framework 214 can further comprise a wrapper component 218 that can provide wrappers around application programming interfaces (APIs) provided by the search engine 104. Such wrappers around APIs provided by the search engine 104 can enable controls executing in the browser 204 to obtain access to search results provided by the search engine 104, query terms provided to the search engine 104, and other user information such as demographics captured by the search engine 104.

The framework 214 can further comprise a display component 220 that can display controls as specified in the metadata of such controls. Specifically, each control of an application can specify when its user interface portion should be displayed to the user and when it should be hidden. For instance, the framework 214 can recognize a plurality of events for display. Exemplary events may include a page load which can be utilized by snippet/caption improving applications on a user click of a controller application link or some custom event. The display component 220 facilitates recognition of separate display parameters for the application in its totality as well as for individual controls. Application level parameters can be used by the display component 220 to determine when a user should be shown a particular application, and a control display can be utilized when the application is visible and is intended for more dynamic interaction with the user.

With more detail pertaining to the ranker component 116, the ranker component 116 can rank applications based upon a variety of metrics. To determine relevancy of an application with respect to a user, the ranker component 116 can consider a query issued by the user if the user has consented to leverage a particular search application in the past, a current user context such as search history or location of the user, signatures corresponding to applications as well as application metrics (which can include ratings assigned to the application by other users of the search engine 104 and click through rates of links corresponding to applications). For instance, if the application is frequently shown to users but is rarely clicked on by users, then the application is most likely not relevant to most users. A signature corresponding to a particular application can be assigned by the developer 208 and can include configuration information (in XML, for instance) that the application developer 208 chooses during application submissions via the validator component 210. These signatures can be evaluated by the validator component 210 to provide an initial application rank. The signature, in an example, can be a conditional statement that is defined and can be processed to identify the relevance and rank of an application. Since user consent and selection of an application is warranted in some scenarios, there are several discovery mechanisms through which users can enable specific search applications for their search experience. For instance, a web site can provide an opt in option for users to opt into specific search applications. The search engine 104 can also non-intrusively suggest specific applications by returning a high ranking search application context together with other search results.

While the framework 214 has been described above as being included in a web browser, it is to be understood that a dedicated search application other than a browser can include the framework 214. For instance, a search application executing on a mobile telephone or tablet computing device can include the framework 214.

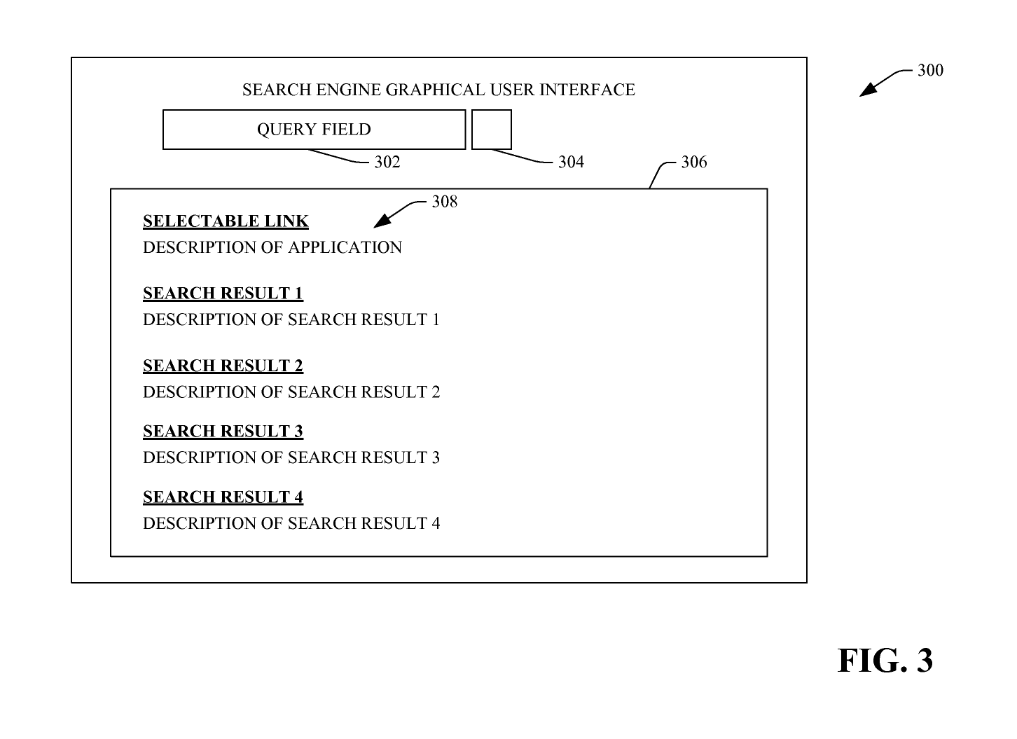

Referring now to FIG. 3, an exemplary graphical user interface 300 of a search engine is illustrated. The graphical user interface 300 comprises a query field 302, wherein a user can enter a query in the query field 302. A push button 304 corresponding to the query field 302 can be depressed by the user when the user wishes to issue a query placed in the query field 302 to a search engine. The graphical user interface 300 further comprises a results field 306 that comprises a plurality of search results that pertain to a query issued by the user. Together with the search results is a selectable link 308 that pertains to an application that can be executed under the umbrella of the search engine. For instance, the application can be a customized search application that is configured to perform searches over a specific domain/vertical. An exemplary vertical may be a vertical for searching available application programming interfaces. Another exemplary vertical may be a vertical for searching three dimensional images of buildings of a certain type of architecture. Still yet another exemplary vertical may be a vertical pertaining to a particular brand of automobile. Thus, it can be ascertained that any suitable application pertaining to a vertical of interest to at least one user can be executed under the umbrella of the search engine.

While the exemplary graphical user interface 300 depicts the selectable link 308 being displayed in the search results field 306, it is to be understood that the selectable link 308 can be presented in other locations in a graphical user interface corresponding to a search engine. For instance, oftentimes search engines comprise a plurality of links that correspond to different verticals (domains), wherein such links are shown together near a top or side of a graphical user interface. In an example, the selectable link 308 can be displayed together with links corresponding to these verticals (e.g., “images”, “shopping”, “news”, . . . ).

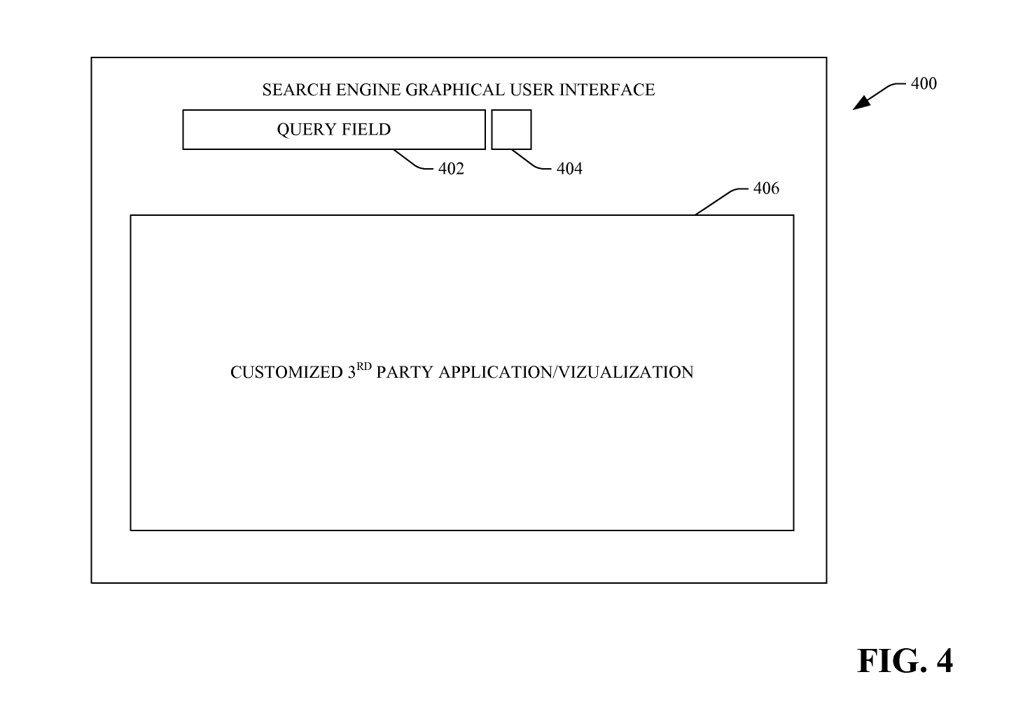

With reference now to FIG. 4, another exemplary graphical user interface 400 that can be presented to a user of a search engine is illustrated. In this example graphical user interface 400, a query field 402 is included with a corresponding push button 404. For instance, the query field 402 may be configured to receive a query that is germane to a particular vertical that includes an application that is executing under the umbrella of the search engine. The graphical user interface 400 may also comprise a visualization field 406 that depicts a customized application and/or visualization that is generated by a third party. As described above, the third party may utilize a software development kit to generate such application/visualization. This application can be presented to other users of the search engine.

In another embodiment, rather than the customized application being displayed in the visualization field 406 that takes up a large portion of space on the graphical user interface 400, the visualization field 406 can be shown as a mini-view inline with the selectable link 308 as shown in FIG. 3. Thus, the user can quickly ascertain if she is interested in obtaining a larger view of the visualization. Upon selection of the selectable link 308 and/or the mini-view, the graphical user interface 400 can be presented to the user.

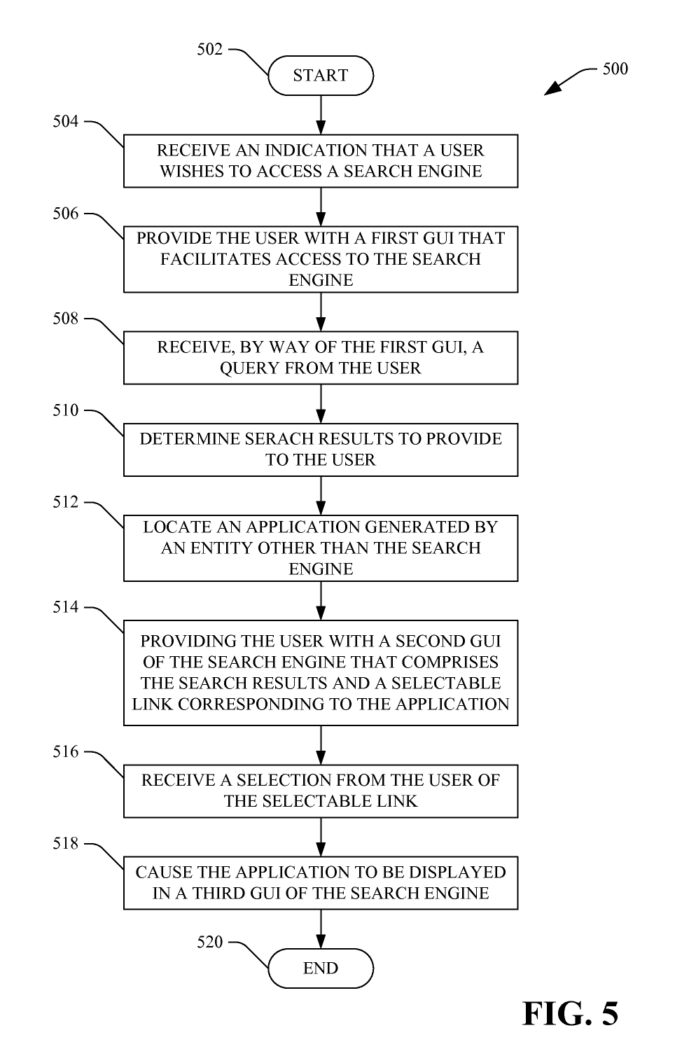

With reference now to FIGS. 5-8, various exemplary methodologies and/or sequence diagrams are illustrated and described. While the methodologies and/or sequence diagrams are described as being a series of acts that are performed in a sequence, it is to be understood that the methodologies and/or sequence diagrams are not limited by the order of the sequence. For instance, some acts may occur in a different order than what is described herein. In addition, an act may occur concurrently with another act. Furthermore, in some instances, not all acts may be required to implement a methodology and/or sequence described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies and/or sequence diagrams may be stored in a computer-readable medium, displayed on a display device, and/or the like. The computer-readable medium may be a non-transitory medium, such as memory, hard drive, CD, DVD, flash drive, or the like.

Referring now to FIG. 5, an exemplary methodology 500 that facilitates displaying a third party application and a graphical user interface of a search engine is illustrated. The methodology 500 begins at 502, and at 504 an indication that a user wishes to access a search engine is received. This can be the user directing a browser to a URL of a general purpose search engine, the user selecting a link that directs the browser to the general purpose search engine, etc.

At 506, the user is provided with a first graphical user interface that facilitates access to the search engine. For instance, this can be referred to as a search engine home page. This home page can include a text entry field, wherein the user can issue a query to the search engine by typing in a query in such text entry field. At 508, a query from the user is received by way of the first graphical user interface.

At 510, search results to be provided to the user are determined based at least in part upon the query received at 508. Thus, the search engine executes a search over documents indexed by such search engine to locate the search results.

At 512, an application is located, wherein the application has been generated or built by an entity other than the search engine. This application can, for instance, be located at least in part upon the query received by the user at 508 or from the search results determined at 510.

At 514, the user is provided with a second graphical user interface of the search engine, wherein the second graphical user interface comprises a search result and selectable link corresponding to the located application. Accordingly, if the user wishes to use a third party application, such user can select the selectable link.

At 516, a selection from the user of the selectable link is received, and at 518 the application is caused to be displayed in a third graphical user interface of the search engine. Furthermore, the query issued by the user at 508 can be provided to the application displayed at 518 and the application can output data based at least in part upon such query. For instance, the application can be a customized application that is configured to perform searches for documents, images, etc. in a particular vertical, and the query provided by the user at 508 can be utilized to search for documents in such vertical. Thereafter, the user can interact with the application displayed in the third graphical user interface of the search engine by clicking on one or more visualizations in such application, etc. This interaction can cause the query initially utilized by the application to be automatically modified as events are generated upon clicking upon certain visualizations in the application. These produced events can cause the query to be altered, which can either change results provided to the user or change the visualization shown to the user in the applications. The methodology 500 completes at 520.

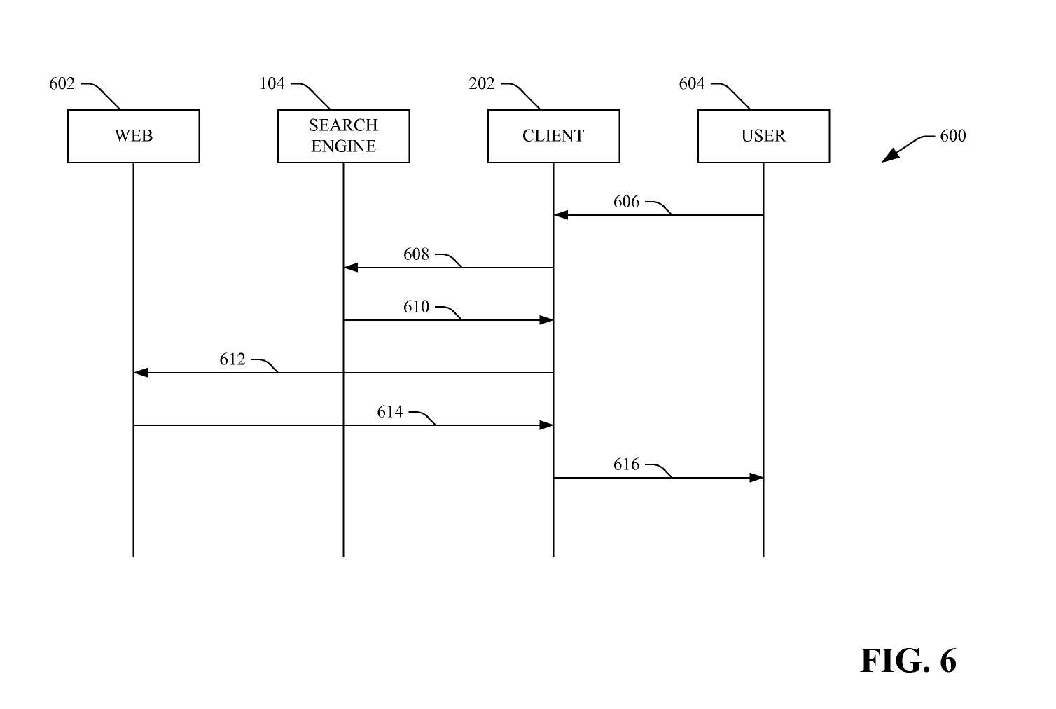

With reference now to FIG. 6, a sequence diagram 600 is illustrated. The sequence diagram 600 illustrates exemplary communications between the World Wide Web 602, the search engine 104, the client computing device 202 and a user 604. This sequence diagram 600 can illustrate communications between the World Wide Web 602, the search engine 104, the client computing device 202 and the user 604 when the user 604 initiates a new search with the search engine 104. At 606, the user 604 initiates a search with the client computing device 202. As described above, the client computing device 202 can have a browser executing thereon, and the user 604 can direct the browser to the search engine 104. Thereafter, the user can proffer a query to the search engine 104 by providing the browser with the query at 606.

At 608, the client computing device 202 transfers the query to the search engine 104. Additionally, the client computing device 202 can transfer other information to the search engine 104 such as context of the user, including location of the user and/or context pertaining to the client computing device 202.

At this point, the search engine 104 can evaluate the query, user context, and device context and can evaluate signatures of third party applications that can be executed in the search engine 104. Based at least in part upon the evaluation of the signatures in view of the query, user context, and device context, the search engine 104 can locate at least one application that may be of interest to the user 604.

At 610, the search engine 104 can cause a framework or portion thereof to be transmitted to the client computing device 202 and can also provide application information to the client computing device 202, wherein such application information can include plug-ins/controls that have been selected by the developer of the application to include in such application as well as configurations of such plug-ins/controls. Additionally, at 610, search results located by the search engine 104 based at least in part upon the query submitted by the user 604 at 606 can be returned to the client computing device 202.

Subsequently, the browser executing in the client computing device 202 can begin to process the applications and visualizations corresponding to such applications. In the example shown in FIG. 6, the application may dynamically update based upon domain specific information that may be available by way of the World Wide Web. Accordingly, the browser executing in the client computing device 202 can query domain specific information from the web 602 at 612. For instance, the application executing in the browser on the client computing device 202 may utilize APIs of the search engine 104 such that the application can perform searches for domain specific content via the web 602 and can update a visualization to the user 604 based at least in part upon this domain specific content retrieved from the web 602. At 614, domain specific content is retrieved from the web 602 and provided to the client computing device 202, which can then update a visualization presented to the user at 616.

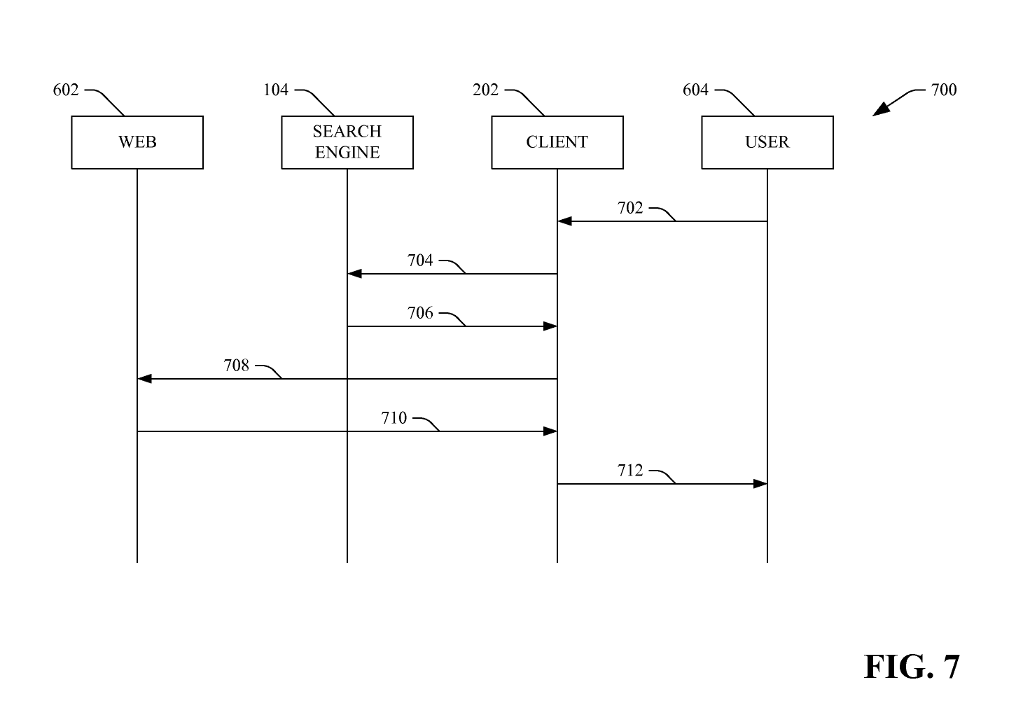

Turning now to FIG. 7, another exemplary sequence diagram 700 is illustrated between the World Wide Web 602, the search engine 104, the client computing device 202 and the user 604. This sequence diagram 700 depicts communications between the World Wide Web 602, the search engine 104, the client computing device 202 and the user 604 when the user interacts with a third party application that is executing in the browser of the client computing device 202 under the umbrella of the search engine 104. At 702, the user 604 in some way interacts with the third party application executing in the browser of the client computing device 202. For instance, the user 604 may utilize a mouse to click on a certain control shown in a graphical user interface, may issue a query, etc. At 704, the browser executing in the client computing device 202 requests an updated view from the search engine 104 based at least in part upon the interaction of the user 604 with the application.

At 706 any additional controls and/or application information and/or search results that are updated based upon the selection or interaction of the user with the application are returned to the client computing device 202. The browser executing in the client computing device 202 may then process the application such that a new visualization is presented to the user 604. At 708, the World Wide Web 602 is accessed to determine if any domain specific information pertaining to the query is to be utilized to augment a visualization presented to the user. Domain specific information 710 is then returned from the World Wide Web 602 to the client computing device 202 for display to the user at 712.

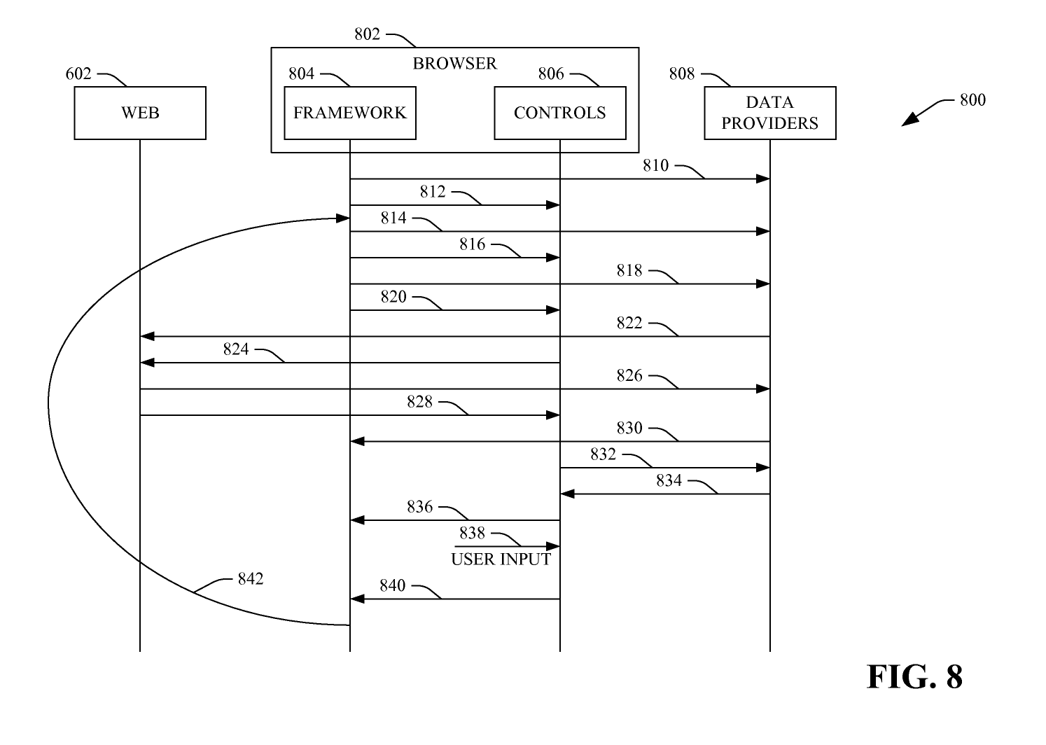

Now referring to FIG. 8, another exemplary sequence diagram 800 is illustrated. This sequence diagram 800 illustrates how a visualization can be processed and provided to the user. Communications are depicted between the World Wide Web 602, a browser 802 executing on a client computing device, wherein the browser 802 includes a framework 804 and one or more controls 806 that are to execute in the browser 802, and data providers 808, which can provide data that is not generally accessible by way of the World Wide Web 602. At 810, the framework 804 can instantiate data providers 808 that the application executing in the browser 802 leverages when performing visualizations to users. For example, these data providers 808 may provide data that is not indexed by the search engine but is made available to the application. Accordingly, the application can leverage data from these data providers 808 to provide visualizations to the user.

At 812, the framework 804 instantiates the controls 806. Thereafter, application configurations can be processed and bindings between controls 806 can be undertaken. Subsequently, some interaction by the user can cause a query utilized by the application to alter. This interaction may be a new query provided by the user and/or an interaction with the visualization in the application undertaken by the user. This interaction can cause an event to fire which may, for instance, automatically cause a query to change. At 814, an indication that the query is changing can be transmitted to the data providers 808 and at 816. Additionally, this same indication can be provided from the framework 804 to the controls 806. Thereafter, at 818 the query can be changed and the framework 804 can inform the data providers 808 of the change to the query. Similarly, at 820 the framework 804 can inform the controls 806 that the query has been altered. At 822, data pertaining to the query that has been updated based upon content of the data providers 808 can be transmitted to the World Wide Web 602 from the data providers 808. At 824 similar data can be transmitted from the controls 806 to the World Wide Web 602.

At 826, domain specific information is returned from the World Wide Web 602 to the data providers 808, and at 828 this information is also provided to the controls 806. At 830, an indication is output from the data providers 808 that a query changing event has been processed and the framework 804 receives such indication. At 832, the controls 806 retrieve data from the data providers 808, and at 834 the data providers 808 return appropriate data to the controls 806. At 836, the controls 806 indicate to the framework 804 that an event has been processed. Thereafter, at 838 additional user input is received which may cause an updated visualization to be shown to the user and at 840 the controls indicate to the framework 804 that a particular control has been invalidated. Additionally, controls dependent upon such controls are invalidated and at 842 the sequence shown in the sequence diagram 800 returns to act 812 to process a new visualization.

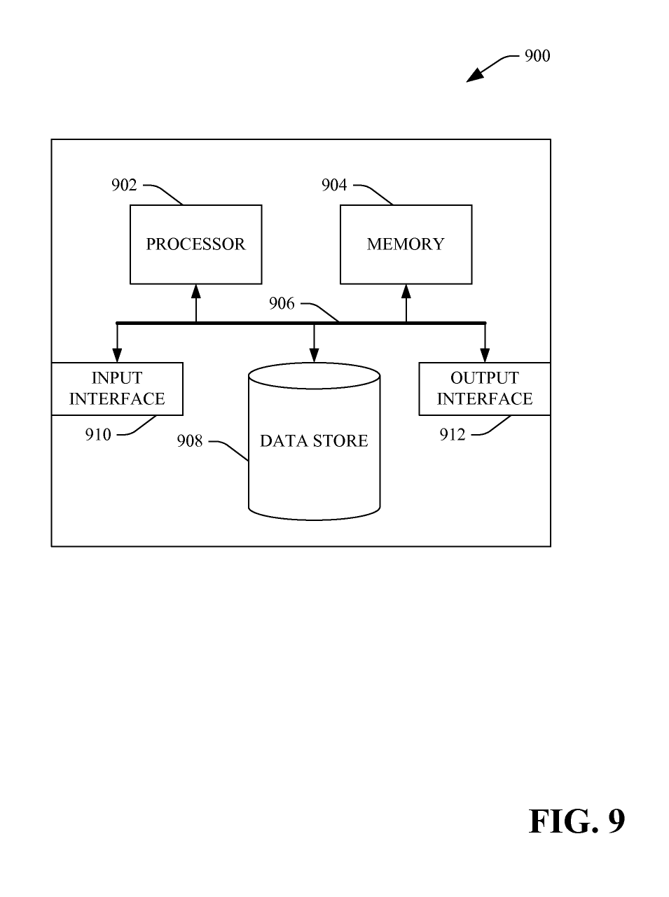

Now referring to FIG. 9, a high-level illustration of an exemplary computing device 900 that can be used in accordance with the systems and methodologies disclosed herein is illustrated. For instance, the computing device 900 may be used in a system that supports presenting a user with an application in a graphical user interface of a search engine that has been generated by a third party. In another example, at least a portion of the computing device 900 may be used in a system that supports providing a software development kit to developers wherein the software development kit can be utilized to generate an application that can execute in connection with a search engine. The computing device 900 includes at least one processor 902 that executes instructions that are stored in a memory 904. The memory 904 may be or include RAM, ROM, EEPROM, Flash memory, or other suitable memory. The instructions may be, for instance, instructions for implementing functionality described as being carried out by one or more components discussed above or instructions for implementing one or more of the methods described above. The processor 902 may access the memory 904 by way of a system bus 906. In addition to storing executable instructions, the memory 904 may also store controls, visualizations, etc.

The computing device 900 additionally includes a data store 908 that is accessible by the processor 902 by way of the system bus 906. The data store may be or include any suitable computer-readable storage, including a hard disk, memory, etc. The data store 908 may include executable instructions, controls, signatures for applications, applications, search results, etc. The computing device 900 also includes an input interface 910 that allows external devices to communicate with the computing device 900. For instance, the input interface 910 may be used to receive instructions from an external computer device, from a user, etc. The computing device 900 also includes an output interface 912 that interfaces the computing device 900 with one or more external devices. For example, the computing device 900 may display text, images, etc. by way of the output interface 912.

Additionally, while illustrated as a single system, it is to be understood that the computing device 900 may be a distributed system. Thus, for instance, several devices may be in communication by way of a network connection and may collectively perform tasks described as being performed by the computing device 900.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices. Furthermore, a component or system may refer to a portion of memory and/or a series of transistors.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method comprising:
receiving an indication that a user wishes to access a search engine;
responsive to receiving the indication, providing the user with a first graphical user interface that facilitates access to the search engine;
receiving, by way of the first graphical user interface, a query from the user;
executing a search over a plurality of documents based at least in part upon the query;
determining search results to provide to the user based at least in part upon the executing of the search over the plurality of documents;
locating an application generated by an entity other than the search engine based at least in part upon at least one of the query, a query previously issued by the user, or the search results; and
subsequent to locating the application and determining the search results, providing the user with a second graphical user interface corresponding to the search engine, wherein the second graphical user interface comprises graphical indicia corresponding to the search results and a selectable link corresponding to the application, wherein user selection of the selectable link causes the application to be displayed to the user in a third graphical user interface that corresponds to the search engine.

2. The method of claim 1, further comprising displaying an advertisement on the third graphical user interface together with the application.

3. The method of claim 2, further comprising:
causing revenue generated from displaying the advertisement on the third graphical user interface to be shared between the search engine and the entity other than the search engine.

4. The method of claim 1, wherein the application is a search vertical that is configured to search over a particular set of documents.

5. The method of claim 1, further comprising:
subsequent to locating the application and prior to receiving a selection of the selectable link from the user, automatically causing data that is utilized by the application to be transmitted to a personal computing device of the user.

6. The method of claim 1, wherein the application is located based at least in part upon a signature assigned to the application.

7. The method of claim 6, wherein the signature comprises features that are based upon at least one keyword that is included in the query or a geographic location of the user.

8. The method of claim 6, wherein the signature comprises features that are based upon at least one keyword that is included in title pages of the search results.

9. The method of claim 1, wherein the application is located based at least in part upon user reviews assigned to the application.

10. The method of claim 1, wherein the application is located based at least in part upon a click-through rate corresponding to the application.

11. The method of claim 1, wherein the application is configured to access data available by way of an intranet, and wherein a search undertaken by way of the application causes data available by way of the intranet to be presented to the user in the third graphical user interface.

12. A system comprising a plurality of computer-executable components, the plurality of components comprising:
a receiver component that receives input from a user; and
a search engine that presents an application to the user responsive to the user input, wherein the application is displayed in a graphical user interface of the search engine as being part of the search engine, wherein the application is submitted to the search engine by an entity that is other than the search engine.

13. The system of claim 12, wherein the application is a search application that is configured to search over a set of documents unavailable in an index utilized by the search engine to perform a search.

14. The system of claim 12, wherein the user input is a query, wherein the search engine locates search results based at least in part upon the query, and wherein the search engine causes a selectable link corresponding to the application to be displayed together with the search results.

15. The system of claim 14, wherein the search engine locates the application for presentment to the user based at least in part upon at least one of the query or the search results.

16. The system of claim 14, further comprising a support component that automatically updates a browser employed by the user with data that supports execution of the application in the browser of the user.

17. The system of claim 14, wherein the search engine locates the application for presentment to the user based at least in part upon a click-through-rate corresponding to the application when presented to users of the search engine.

18. The system of claim 12, wherein the application is an interactive application.

19. The system of claim 12, wherein the search engine displays an advertisement on the graphical user interface of the search engine together with the application.

20. A non-transitory computer-readable medium comprising instructions that, when executed by a processor, cause the processor to perform acts comprising:
receiving a query from a user;
locating a plurality of search results based at least in part upon the query;
based at least in part upon the query and the search results, locating an application developed by a third party;
automatically causing data that supports execution of the application in a browser executing on a client computing device of a user to be transmitted to the client computing device of the user;
displaying the search results and a selectable link corresponding to the application on a graphical user interface of the search engine;
receiving from the user a selection of the selectable link;
causing the application to be displayed on the graphical user interface of the search engine;
receiving user input with respect to the application; and
causing the application to display output on the graphical user interface of the search engine.
